(19) United States
(12) Patent Application Publication
(10) Pub. No.: US 2018/0032003 A1
(43) Pub. Date: Feb. 1, 2018

(54) USE OF ACTIVE STATIC ELIMINATION ON UN-FUSED PRINTS IN AN ELECTROSTATIC PRINTING APPARATUS

(71) Applicant: XEROX CORPORATION, Norwalk, NY (US)

(72) Inventors: Robert W. PHELPS, Victor, NY (US); John T. BUZZELLI, Walworth, NY (US); David S. DERLETH, Webster, NY (US); John R. LAMBIE, Ontario, NY (US)

(21) Appl. No.: 15/222,534

(22) Filed: Jul. 28, 2016

(51) Int. Cl. G03G 15/00; G03G 15/20; G03G 21/00

(52) U.S. Cl. CPC G03G 15/1665; G03G 21/203

(57) ABSTRACT

A method and system for reducing contamination build-up within a fuser roll system are disclosed where there is provided the positioning of an active static eliminator over the pre-fuser transport. This device will neutralize the charge on the surface of the toner after transfer/detack thereby reducing the attraction to the surface of the fuser roll which is conductive and grounded.

### BACKGROUND OF THE INVENTION

Disclosed herein are methods directed to an electrophotographic printing machine and, more particularly, to a fuser roll system including a static eliminator to reduce contamination on the fuser roll.

Electrostatic reproduction involves an electrostatically-formed latent image on a photoconductive member, or photoreceptor. The latent image is developed by bringing charged developer materials into contact with the photoconductive member. The developer materials can include two-component developer materials including carrier particles and charged toner particles for such as “hybrid scavengeless development” having an image-on-image development. The developer materials can also include single-component developer materials including only toner particles. The toner particles are transferred to the photoconductive member from a toner cloud generated during the development process.

The toned image on the photoconductive member is advanced to a transfer station where an image-receiving substrate such as a sheet of paper is moved into contact with the photoconductive member to transfer the image via any suitable process. The image-receiving substrate is then advanced to a fusing station to fix or fuse the toner material onto the image-receiving substrate permanently by heat.

Conventional fusing stations include a fuser roll and a pressure roll to fuse the toner to the substrate. Over time, contamination can build up on the surface of the fuser roll. Specifically, toner resin build-up on the fuser roll from various forms of offset, gelled oil, pigment staining, and Zinc. Fumarate, a byproduct of additives and toner resin. Further, the contamination can lead to a pigment building up on the fuser roll or penetration of the top-coat material.

Currently, the only countermeasure to the increased toner contamination evident with the CNT/CPR roll pair is to increase the speed of the x-roll web cleaner based on the requested media. This is not an optimum solution because it doesn't address the root cause of the reduced fuser roll life which is toner contamination on the surface of the fuser roll. Increasing the web speed improves the removal of toner contamination from the x-rolls and extends the length of time it takes for toner build up on the x-rolls to back transfer to the surface of the fuser roll. It does not prevent the initial deposition of toner to the surface of the fuser roll.

### BRIEF SUMMARY OF THE INVENTION

According to aspects of the embodiments, there is provided methods that position an active static eliminator over the pre-fuser transport. This device will neutralize the charge on the surface of the toner after transfer/detack thereby reducing the attraction to the surface of the fuser roll which is conductive and grounded.

### BRIEF DESCRIPTION OF THE DRAWINGS

FIG. 1 illustrates an example of a conventional fuser module and the excess toner contamination phenomenon that may be addressed by the systems and methods according to this disclosure;

FIG. 2 shows the location of the active static eliminator in an image forming device according to this disclosure;

FIG. 3 illustrates a block diagram of an exemplary system for operating an image forming device with one or more particularly-configured external heat rolls according to this disclosure;

FIG. 4 illustrates a flowchart of an exemplary method for operating an image forming device with one or more particularly-configured external heat rolls according to this disclosure; and

FIG. 5 is a view illustrating the active static eliminator positioned over the pre-fuser transport in accordance to an embodiment.

### DETAILED DESCRIPTION OF THE INVENTION

The systems and methods for reducing excess toner contamination in image forming devices through providing and implementing contact surfaces on individual rolls, including external heat rolls in the image forming devices, the image forming device being configured with an active static eliminator that neutralizes the charge on the surface of the toner after transfer/detack thereby reducing the attraction to the surface of the fuser roll which is conductive and grounded.

Exemplary embodiments described and depicted in this disclosure should not be interpreted (1) as being specifically limited to any particular configuration of an image forming device, or any individual module, including a fuser module, housed within, or otherwise associated with, an image forming device, or (2) as being directed to any particular limiting intended use. In fact, any excess toner contamination remediation system, component or technique that may benefit from the systems and methods of implementing active static elimination of charges on toner material is contemplated.

Exemplary embodiments are intended to cover all alternatives, modifications, and equivalents as may be included within the spirit and scope of the composition, apparatus and systems as described herein.

A more complete understanding of the processes and apparatuses disclosed herein can be obtained by reference to the accompanying drawings. These figures are merely schematic representations based on convenience and the ease of demonstrating the existing art and/or the present development, and are, therefore, not intended to indicate relative size and dimensions of the assemblies or components thereof. In the drawing, like reference numerals are used throughout to designate similar or identical elements.

Example 1 includes an image forming device comprising a transfer station comprising a developer unit to deposit charged toner particles of a selected color on a print substrate; an adjoining fusing station having fuser roll which is conductive and grounded; a pre-fuser media transport positioned between the transfer station and the fusing station and at least one movable belt being configured to move across the top section to transport the print substrate and the deposited charged toner particles from the transfer station to the fusing station; and an active static eliminator positioned between the transfer station and the fusing station to neutralize a charge on the surface of the charged toner particles before it is fused at the fusing station.

Example 2 includes example 1 and the fusing station further comprising a heated roll body formed at least in part of a material having a high thermal conductivity and configured to be rotatable around a center longitudinal axis; and a low surface energy surface on an outer surface of the heated roll body, the low surface energy surface comprising: a coarse surface component formed of an anodized material that presents contact peaks and associated valleys; and a low surface energy material component that only partially fills or lines the associated valleys.

Example 3 includes example 2 and the low surface energy surface being an outer surface layer coating over a longitudinal surface of the heated roll body.

Example 4 includes example 3 and the heated roll body having a multi-layer construction consisting of two layers of substantially a same thickness, the two layers comprising: an inner layer formed of a high thermal conductivity material; and an outer layer comprising the low surface energy surface.

Example 5 includes example 2 and wherein the active static eliminator is at least one static eliminator selected from the group consisting of an ion discharge-type static eliminator, a corona discharge-type static eliminator and a self-discharge-type static eliminator.

Example 6 includes example 5 and wherein the active static eliminator being configured to eliminate static electricity from a first layer on the pre-fuser media transport and a top layer on the print substrate.

Example 7 includes example 2 and wherein the active static eliminator having discharge needles and a voltage control circuit to control a discharge voltage applied to the discharge needles, the active static eliminator being configured to eliminate static electricity from the charged toner particles by a DC discharge based on the discharge voltage through a corona discharge.

Example 8 includes example 7 and wherein the voltage control circuit sets the discharge voltage of the discharge needles at a value between xxV and xyV.

Example 9 includes example 8 and further comprising temperature and humidity detecting sensors configured to detect temperature and humidity.

Example 10 includes example 8 and wherein the voltage control circuit is configured to control the discharge voltage of the active static eliminator according to detection results of the temperature and humidity detecting sensors.

Example 11 includes a method of operating a image forming device comprising a transfer station comprising a developer unit to deposit charged toner particles of a selected color on a print substrate; an adjoining fusing station having fuser roll which is conductive and grounded; and a pre-fuser media transport positioned between the transfer station and the fusing station and at least one movable belt being configured to move across the top section to transport the print substrate and the deposited charged toner particles from the transfer station to the fusing station, the method of operating the image forming device comprising neutralizing with an active static eliminator, positioned between the transfer station and the fusing station, a charge on the surface of the charged toner particles before it is fused at the fusing station.

Embodiments as disclosed herein may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, and the like that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described therein.

Although embodiments of the invention are not limited in this regard, discussions utilizing terms such as, for example, “processing,” “computing,” “calculating,” “determining,” “using,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of stations” may include two or more stations. The terms “first,” “second,” and the like, herein do not denote any order, quantity, or importance, but rather are used to distinguish one element from another. The terms “a” and “an” herein do not denote a limitation of quantity, but rather denote the presence of at least one of the referenced item.

For illustrative purposes, although the term “fuser” is used herein throughout the application, it is intended that the term “fuser” also encompasses members useful for a printing process or in a printing system including, but not limited to, a fixing member, a pressure member, a heat member, and/or a donor member.

The term “marking material” as used herein encompasses any colorant or other material used to mark on paper or other print media. Examples of marking material include inks, solid ink, gel ink, toner particles, pigments, and dyes.

The terms “print media”, “print substrate” and “print sheet” generally refers to a usually flexible, sometimes curled, physical sheet of paper, Mylar material, plastic, or other suitable physical print media substrate for images, whether precut or web fed.

Many modern image forming devices have internal processing components that are composed of one or more heated roll elements, or heat rolls. Principally, such heated roll elements are included as heated fuser rolls, and/or associated heated rolls for transferring heat to a surface of a fuser roll, in one or more toner fusing and fixing modules. These heated roll elements are formed of materials that demonstrate progressively increasing thermal conductivity over conventional heat rolls. The increased thermal conductivity on and through the surfaces of the heated fuser-system rolls may be provided through an implementation of carbon nanotube technology (CNT). An advantage of the increased surface thermal conductivity enables fusing at higher speeds for increased productivity in the image forming devices in which the advanced rolls are employed.

The advantages of implementing the heated roll elements, or heat rolls, with increased thermal conductivity are offset somewhat by what has emerged as an observed disadvantage or dysfunction to their use. This disadvantage or dysfunction, particularly associated with the interaction of higher thermal conductivity CNT heated fuser rolls and cooperating conductive pressure rolls (CPRs) at the fusing nip, is an increase in a toner dirt contamination rate from excess toner contamination.

The increase in toner dirt contamination rate is attributable to the interaction between the CNT and CPR rolls, and the charge on the surface of the marking material that tends to bind to the rolls due to electrostatic build up on the roll surfaces.

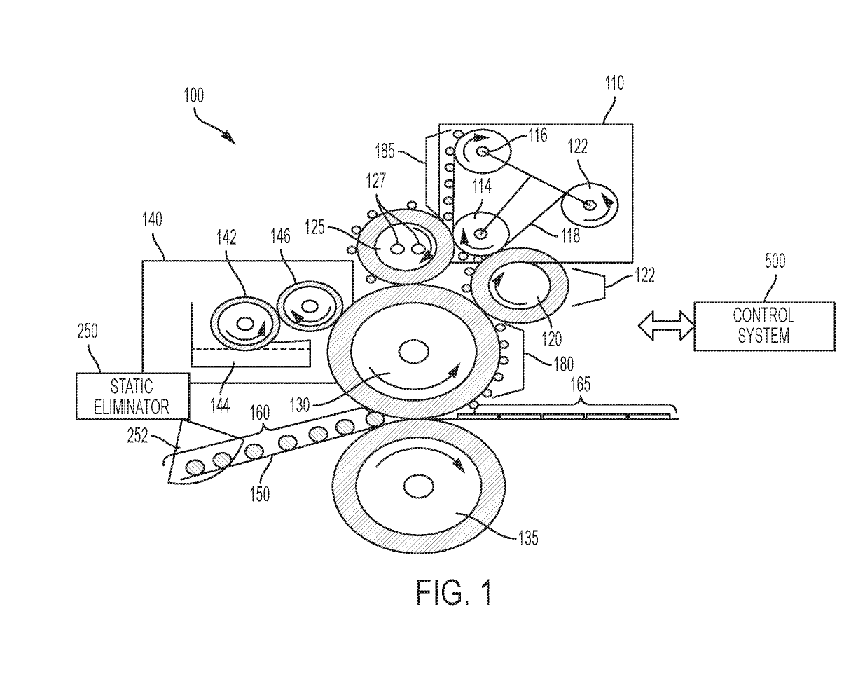

In a typical advanced fuser module 100 for use in a modern image forming system such as that shown, for example, in FIG. 1, a plurality of roll elements are used, in combination, to fix and finish images consisting of a combination of unfused toner elements or charged toner particles 160 deposited on image receiving media substrates that are transported to the fuser module 100 from a marking module (not shown) on an image receiving media substrate transport 150 or pre-fuser transport. A fusing nip is formed between the CPR 135 and the increased thermal conductivity CNT heated fuser roll 130 to fuse and fix the image 165 on the substrate.

An oiler unit 140 may be typically provided to condition a surface of the increased thermal conductivity CNT heated fuser roll 130 to promote highest efficiency fusing in a manner that attempts to substantially limit back transfer of unfused toner material particles 180 to the increased thermal conductivity CNT heated fuser toll 130. Back transfer is a phenomenon in which, based on subtle differences in adherence properties, a certain, even small, percentage of toner adheres to the heated surfaces rather than to the image receiving media substrate emerging from the fuser nip in the fusing and fixing process. These unfused toner particles adversely affect image quality of subsequent images processed at the fuser nip. The oiler unit 140 may typically include, for example, a metering roll 142, an oil reservoir 144 and a donor roll 146 that combine to provide a renewable surface conditioning coating on a surface of the increased thermal conductivity CNT heated fuser roll 130 to reduce the proclivity of the surface to adherence.

Regardless of the attempts at mitigation to date, a portion of the unfused toner elements 160 continue to separate as unfused toner material particles 180 and travel over a surface of the increased thermal conductivity CNT heated fuser roll 130 and a first external heat roll 120 and a second external heat roll 125. The external heat rolls 120, 125 may be heated internally with one or more internal heating elements 127, or one or more external heating elements 122, or combinations thereof.

In certain image forming systems, additional processing elements are added to further mitigate the adverse effects of adhered unfused toner particle contamination, including use of a web cleaner system 110. The web cleaner system 110 may typically consist of a web supply roll 112, a web contact roll 114, and a web take-up roll 116 about which a web cleaning material 118 is disposed in a manner that allows for collection of the unfused toner material particles 180.

As processing speeds increase, particularly in image forming operations that are conducted against certain high stress conditions, the excess toner contamination will ultimately over saturate the web cleaning material 118 in a typical web cleaner system 110, thereby adversely affecting an ability of the web cleaner system 110 to effectively pick up the loose unfused toner material particles 180 from the surfaces of the first external heat roll 120 and the second external heat roll 125. Once any of the components of the fuser module 100 become over saturated with unfused toner material particles 180, the unfused toner material particles 180 will remain on, or will be re-deposited on, surfaces of the second external heat roll 125, the fuser roll 130 and the first external heat roll 120. The excess toner contamination will eventually re-manifest itself in creating image defects that the mitigation efforts were intended to address. An additional adverse effect of the excess toner contamination, in addition to the image defects that are not addressed, is the potential for inducing premature fuser roll failure. Other adverse effects may include reduction in external heat roll cleaning intervals, and increases in occurrences of toner chunks in the system due to web material over saturation. The accumulated and un-cleaned toner chunks may also fall on a surface of the image receiving media substrate upstream of the fusing nip in a process direction leading to the image defects.

Current methodologies, techniques and/or schemes for mitigating or countering these issues generally involve increasing a speed of the web cleaner system 110 in attempts to maintain an effective cleaning rate for stress media. The difficulty is that this “solution” has its own inherent drawback of adversely affecting run cost for image production in the image forming device of which the fuser module 100 is a part. Simply increasing the web speed alone may prove ineffective in providing the necessary cleaning latitude to support increasing image forming capacity available with the use of increasingly thermally conductive fuser rolls rendering this workaround, at best, a partial or limited solution to the difficulties arising from excess toner contamination. Further, it should be recognized that, to be more effective, the conventional methodologies may require an increase in a number of manual cleaner cycles and/or servicing for a particular image forming device. These manual cleaner cycles and/or servicing may involve stopping production in the involved image forming devices. Those skilled in the art recognize that each such stoppage for service may involve not only the time for the cleaning operation itself, but otherwise extended periods of inactivity for the heated components to cool before being serviced.

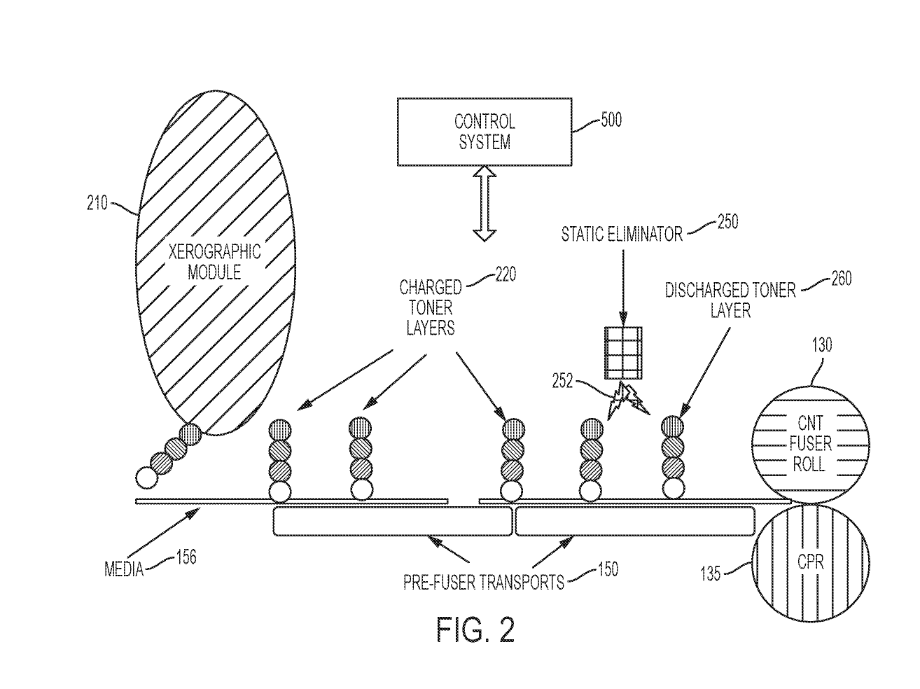

It is proposed positioning an active static eliminator 250 that is controlled by control system 500 which also controls various modules of the imaging system, over the pre-fuser transport. This device will neutralize the charge on the surface of the toner after transfer/detack thereby reducing the attraction to the surface of the fuser roll which is conductive and grounded. Next, another embodiment of the present invention will be described. Note that portions which are the same as those in the first embodiment described above are denoted by the same reference numerals, and descriptions of the same portions as those as in the first embodiment will be omitted. FIG. 2 shows the location of the active static eliminator in an image forming device according to this disclosure. Print substrate 156 arrives at the xerographic module with a uniform electrostatic charge as deposited on the surface by a corona discharge device (not shown). The xerographic module 210 or transfer station comprising a developer unit deposits charged toner particles 160 of selected colors on the print substrate 156 that binds to the print substrate. These charged toner particles are layered on the print substrate to form charged toner layers 220.

The print substrates are transported by pre-fuser transports 150 to a fusing station that comprises rollers CNT 130 and CPR 135. There is a substantial charge on the surface of the media as well as the charge on the un-fused toner layer before they enter the fuser nip formed by CNT 130 and CPR 135. Since surface of the CNT is conductive and at ground with the surface of the pressure roll floating there is an electrostatic build up on the roll surfaces. With the CNT/CPR roll pair it has been observed that the majority of the contaminants that pollute the fuser oil reservoir are what would be the top toner layer on the un-fused print entering the nip. Standard CNT/CPR fuser oil contaminates primarily with Magenta toner, which is the first layer on the photoreceptor and the top layer on the media. It has also been observed that there is a seasonal component to the toner contamination, i.e., fuser roll life decreases in the fall and winter months when the relative humidity is low and electrostatic charging effects would be increased.

The image reproducing system has been outfitted with an active static eliminator positioned over the pre-fuser transport. To extend fuser roll life (CNT/CPR) an active static eliminator 250 is used to neutralize the charge on the surface of the print substrate 150 as well as the charge on the un-fused toner layer 220 before it enters the fuser nip. Stress testing was performed and it has been observed that fuser roll life is increased 2x by eliminating the static charge on at least the un-fused toner layer. The active static eliminator 250 can be equipped with the logic and hardware like described in control system 500 to incorporate such parameters as temperature, humidity, and toner type and materials to selectively activate the static eliminator.

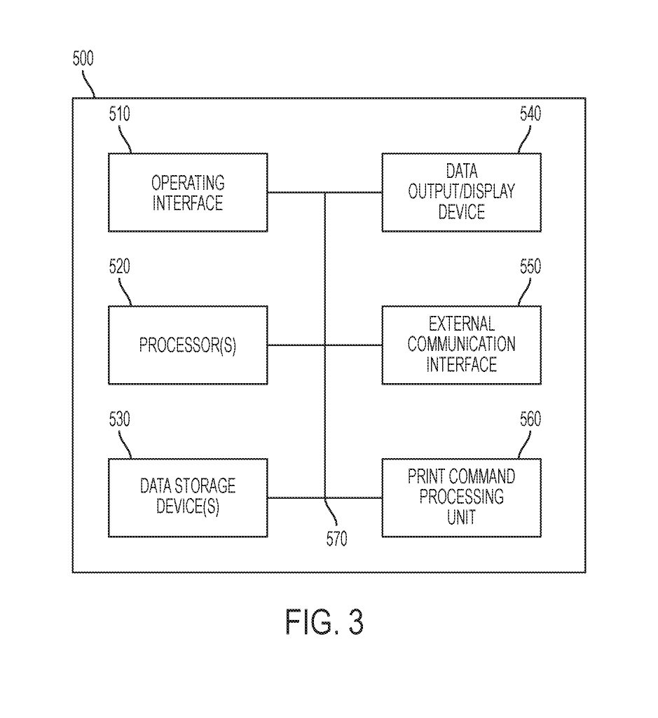

FIG. 3 illustrates a block diagram of a controller with a processor for executing instructions to automatically control devices in the apparatus illustrated in FIG. 1 or FIG. 2 in accordance to an embodiment.

Components of the exemplary system 500 shown in FIG. 3 may be, for example, housed in a user workstation, in a server or in an image forming device.

The exemplary system 500 may include an operating interface 510 by which a user may communicate with the exemplary system 500, or otherwise by which the exemplary system 500 may receive instructions input to it from another source. In instances where the operating interface 510 may be a locally accessible user interface, the operating interface 510 may be configured as one or more conventional mechanisms common to computing and/or image forming devices that permit a user to input information to the exemplary system 500. The operating interface 510 may include, for example, a conventional keyboard and mouse, a touchscreen with “soft” buttons or with various components for use with a compatible stylus, a microphone by which a user may provide oral commands to the exemplary system 500 to be “translated” by a voice recognition program, or other like device by which a user may communicate specific operating instructions to the exemplary system 500.

The exemplary system 500 may include one or more local processors 520 for individually operating the exemplary system 500 and for carrying out processing, assessment, reporting and control functions. Processor(s) 520 may include at least one conventional processor or microprocessor that interprets and executes instructions to direct specific operation and analysis functions with regard to image data that is commanded or intended to direct image forming in a specific image forming device with which the exemplary system 500 is associated.

The exemplary system 500 may include one or more data storage devices 530. Such data storage device(s) 530 may be used to store data or operating programs to be used by the exemplary system 500, and specifically the processor(s) 520, in carrying out the image forming control functions of the exemplary system 500. Data storage device(s) 530 may be used to collect information regarding any or all of the functions of the exemplary system 500. The data storage device(s) 530 may include a random access memory (RAM) or another type of dynamic storage device that is capable of storing collected information, and separately storing instructions for execution of system operations by, for example, processor(s) 520. Data storage device(s) 530 may also include a read-only memory (ROM), which may include a conventional ROM device or another type of static storage device that stores static information and instructions for processor(s) 520. Further, the data storage device(s) 530 may be integral to the exemplary system 500, or may be provided external to, and in wired or wireless communication with, the exemplary system 500.

The exemplary system 500 may include at least one data output/display device 540, which may be configured as one or more conventional mechanisms that output information to a user, including a display screen on a computing or image forming device, including a graphical user interface (GUI) on the image forming device. The data output/display device 540 may be usable to display to a user an indication of image forming data, and a selection of image receiving media, that may be evaluated to indicate a control function to mitigate adverse effects of excess toner contamination associated with a particular image forming operation in an image forming device. The data output/display device 340 may then be usable, in conjunction with the operating interface 310 to display to a user a series of options for optimized image forming operations in the image forming device.

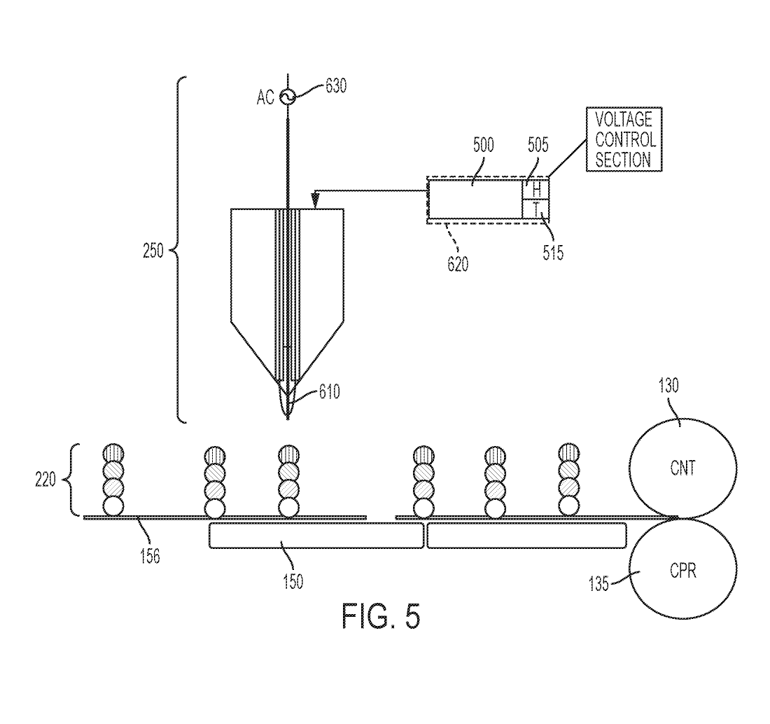

The exemplary system 500 may include one or more separate external communication interfaces 550 by which the exemplary system 500 may communicate with components external to the exemplary system 500, or by which the exemplary system 500 may communicate with an image forming device with which the exemplary system 500 may be associated when it is not fully integral to the image forming device. No particular limiting configuration to the external communication interface(s) 550 is to be implied by the depiction in FIG. 5, other than that the external communication interface(s) 550 may be configured to connect to external components via one or more available wired or wireless communication links.

The exemplary system 500 may include a print command processing unit 560, which may be a part or a function of processor 520 coupled to, for example, one or more storage devices 530, or may be a separate stand-alone component module or circuit in the exemplary system 500. The print command processing unit 560 may review control and image data that specify an image forming operation to be carried out by the image forming device. The print command processing unit 560 may then control the image forming operation in the image forming device according to the control and image data, and particularly control heat levels in one or more heated roll components in the image forming device.

All of the various components of the exemplary system 500, as depicted in FIG. 5, may be connected by one or more data/control busses 570. These data/control busses 570 may provide wired or wireless communication between the various components of the exemplary system 500, whether all of those components are housed integrally in, or are otherwise external and connected to, the exemplary system 500.

It should be appreciated that, although depicted in FIG. 5 as what appears to be an integral unit, the various disclosed elements of the exemplary system 500 may be arranged in any combination of sub-systems as individual components or combinations of components, integral to a single unit, or external to, and in wired or wireless communication with the single unit of the exemplary system 500. In other words, no specific configuration as an integral unit or as a support unit is to be implied by the depiction in FIG. 5. Further, although depicted as individual units for ease of understanding of the details provided in this disclosure regarding the exemplary system 500, it should be understood that the described functions of any of the individually-depicted components may be undertaken, for example, by one or more processors 520 connected to, and in communication with, one or more data storage devices 530.

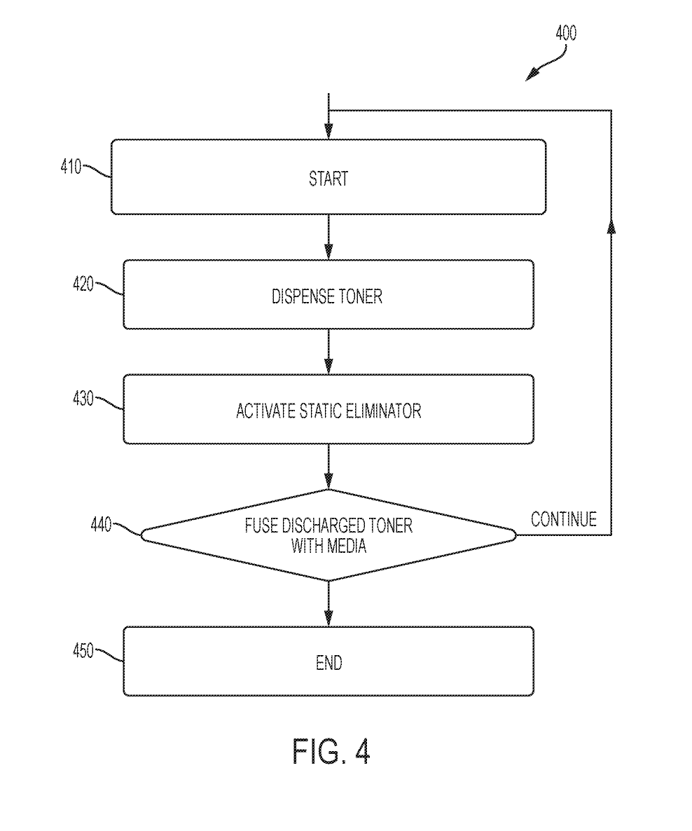

The disclosed embodiments may include an exemplary method for operating an image forming device with one or more external heat rolls. FIG. 4 illustrates a flowchart of such an exemplary method. As shown in FIG. 4, operation of the method commences at action 410 and proceeds to Actions 420, 430, 440, and 450. Action 420 dispenses the charged toner particles; action 430 activates the static eliminator; action 440 a determination is made as to whether or not the print substrate and toner have been fused and whether the process should be terminated (action 450) or continued by returning to action 410 and starting the process again; and, in action the 450 the process is terminated.

Having thus outlined several embodiments of printing apparatus and processes, and described various sequences of operation, reference is now made to FIG. 5 showing a further embodiment. Unless otherwise noted, elements similar to those previously described have been given the same reference numerals and serve the same functions.

FIG. 5 is a view illustrating the active static eliminator positioned over the pre-fuser transport in accordance to an embodiment.

The active static eliminator 250, which disposed over the pre-fuser transport 150, is configured to expose the toner 220 to a DC discharge of a predetermined polarity to eliminate static electric charges from the un-fused toner layer 220 before it enters the fuser nip. The active static eliminator 250 includes a plurality of discharge needles 610 and a voltage control section 620. The active static eliminator 250 is connected to a high-voltage supply source 630. The discharge needles 610 are capable of initiating a corona discharge (252 at FIG. 2) from their distal ends to provide a DC discharge. The voltage control section 620 is configured or programmed to control the voltage value or the corona discharge at needles 610. The plurality of discharge needles 610 are arranged at several centimeter or millimeter intervals in the width direction of print substrate 156 to form essentially a Static Eliminator Bar. The arrangement of the plurality of discharge needles 610 in this manner provides efficient static elimination of the toner on the recording paper sheet.

The voltage control section 620 with a suitable controller, such as controller 500, can change the discharge voltage of the active static eliminator 250 according to data provided by environmental sensor such as humidity sensor 505 and temperature sensor 515. Having temperature and humidity as triggers for the corona discharge addresses the seasonal component to toner contamination, i.e., fuser roll life decreases in the fall and winter months when the relative humidity is low and electrostatic charging effects would be increased. As noted earlier the charge on the toner causes it to stick to the rolls leading to degradation and a lowering of roller life. Specifically, the active static eliminator 250 changes the discharge voltage according to the detection results of the temperature and humidity sensors. A discharge voltage of the discharge needles at a value between 2 kV and 5 kV. Thus, the active static eliminator 250 runs a DC discharge with a voltage suitable for the current temperature and humidity of the interior of the image forming apparatus, thus providing an improvement in the effect of eliminating static electricity from the toner after it is dispense but before it is introduced into the nip formed by roller pairs 130 and 135.

In view of the above shortfalls in conventional solutions, it would be advantageous to provide systems, methods, techniques, schemes and/or processes that may include particularly-configured heat rolls to aid in further mitigating the adverse effects of the excess toner contamination, particularly in fuser modules, in image forming devices.

FIG. 4 illustrates a flowchart of an exemplary method for operating an image forming device with one or more particularly-configured external heat rolls according to this disclosure.

Computer readable program code for carrying out operations for aspects of the present invention may be written in any combination of one or more programming languages, including an object oriented programming language such as Java, Smalltalk, C++ or the like and conventional procedural programming languages, such as the “C” programming language or similar programming languages like Perl or Python. The computer readable program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, and the like that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described therein.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. An image forming device comprising:
a transfer station comprising a developer unit to deposit charged toner particles of a selected color on a print substrate;
an adjoining fusing station having fuser roll which is conductive and grounded;
a pre-fuser media transport positioned between the transfer station and the fusing station and at least one movable belt configured to transport the print substrate and the deposited charged toner particles from the transfer station to the fusing station;
an active static eliminator positioned between the transfer station and the fusing station to neutralize a charge on the surface of the charged toner particles before it is fused at the fusing station;
temperature and humidity detecting sensors configured to detect temperature and humidity;
a heated roll body formed at least in part of a material having a high thermal conductivity and configured to be rotatable around a center longitudinal axis; and
a voltage control circuit determining a discharge voltage based on the detected temperature and humidity;
wherein the active static eliminator is selected from the group consisting of an ion discharge-type static eliminator, a corona discharge-type static eliminator and a self-discharge-type static eliminator;
wherein the active static eliminator has discharge needles and the voltage control circuit to control the discharge voltage applied to the discharge needles, the active static eliminator being configured to eliminate static electricity from the charged toner particles by a DC discharge based on the discharge voltage through a corona discharge;
wherein elimination of static electricity from the charge toner particles mitigates toner contamination associated with a particular image forming operation at the fuser roll.

2. (canceled)

3. The image forming device of claim 1, the low surface energy surface being an outer surface layer coating over a longitudinal surface of the heated roll body.

4. The image forming device of claim 3, the heated roll body having a multi-layer construction consisting of two layers of substantially a same thickness, the two layers comprising: an inner layer formed of a high thermal conductivity material; and
an outer layer comprising the low surface energy surface.

5. (canceled)

6. (canceled)

7. (canceled)

8. The image forming device of claim 1, wherein the voltage control circuit sets the discharge voltage of the discharge needles at a value between 2 kV and 5 kV.

9. (canceled)

10. (canceled)

11. A method of operating a image forming device comprising:
a transfer station comprising a developer unit to deposit charged toner particles of a selected color on a print substrate;
an adjoining fusing station having fuser roll which is conductive and grounded;
a pre-fuser media transport positioned between the transfer station and the fusing station and at least one movable belt being configured to transport the print substrate and the deposited charged toner particles from the transfer station to the fusing station, the method of operating the image forming device comprising:
neutralizing with an active static eliminator, positioned between the transfer station and the fusing station, a charge on the surface of the charged toner particles before it is fused at the fusing station;
using temperature and humidity detecting sensors configured to detect temperature and humidity;
determining with a voltage control circuit a discharge voltage based on the detected temperature and humidity;
a heated roll body formed at least in part of a material having a high thermal conductivity and configured to be rotatable around a center longitudinal axis; and
wherein the active static eliminator is selected from the group consisting of an ion discharge-type static eliminator, a corona discharge-type static eliminator and a self-discharge-type static eliminator;
wherein the active static eliminator has discharge needles and the voltage control circuit to control the discharge voltage applied to the discharge needles, the active static eliminator being configured to eliminate static electricity from the charged toner particles by a DC discharge based on the discharge voltage through a corona discharge;
wherein elimination of static electricity from the charge toner particles mitigates toner contamination associated with a particular image forming operation at the fuser roll.

12. (canceled)

13. The image forming device of claim 11, the low surface energy surface being an outer surface layer coating over a longitudinal surface of the heated roll body.

14. The method of claim 13, the heated roll body having a multi-layer construction consisting of two layers of substantially a same thickness, the two layers comprising: an inner layer formed of a high thermal conductivity material; and
an outer layer comprising the low surface energy surface.

15. (canceled)

16. (canceled)

17. (canceled)

18. The method of claim 11, wherein the voltage control circuit sets the discharge voltage of the discharge needles at a value between 2 kV and 5 kV.

19. (canceled)

20. (canceled)
